(19) United States
(12) Patent Application Publication
(10) Pub. No.: US 2022/0348812 A1
(43) Pub. Date: Nov. 3, 2022

(54) TRANSFORMER POWER ENHANCEMENT

(71) Applicant: ARKEMA FRANCE, COLOMBES (FR)

(72) Inventors: Jeremie WALKER, PIERRE-BENITE cedex (FR); Bernard MONGUILLON, COLOMBES CEDEX (FR)

(21) Appl. No.: 17/765,050

(22) PCT Filed: Sep. 18, 2020
(86) PCT No.: PCT/FR2020/051620

§ 371 Date: Mar. 30, 2022

(30) Foreign Application Priority Data
Oct. 1, 2019 (FR) 1910864

(51) Int. Cl. C09K 5/10; H01F 27/12; H01F 27/10

(52) U.S. Cl. CPC C09K 5/10; H01F 27/12; H01F 27/105

(57) ABSTRACT

The present invention relates to the use, for increasing the power of a transformer, of at least one dielectric fluid of general formula (1):

(A-X)ₙ-B (1)

in which A and B, which are identical or different, represent, independently of each other, an optionally substituted aromatic ring, X represents a spacer group and n represents 0, 1, 2 or 3.
The invention also relates to a transformer containing at least one dielectric fluid of general formula (1).

The market for dielectric oils, also called dielectric fluids, for transformers is continually growing. This market is related to an increasingly great demand for energy in industrialized countries due in particular to electrification of countries experiencing economic growth.

Furthermore, it is increasingly required to use dielectric fluids with a biodegradability of the order of 40% in 28 days according to the OECD 301 standard, for obvious reasons of environmental protection.

Furthermore, the transformers currently in service are often used at load rates of greater than 95%. The current network today comprises a very large number of optimized transformers, that is to say whose losses are minimized. In point of fact, the increasing demands for electricity lead to problems on this optimized present network which today is saturated or close to saturation.

One solution to these problems might consist in installing new transformers. However, this would lead to a not insignificant additional cost and would require additional space often not hugely available for new transformers.

Another solution might consist in replacing the existing transformers by new transformers of higher power. Here again, the costs of these new, more powerful and larger transformers are also not insignificant. This type of development generates, in addition to the price of the transformer, various associated costs for the commissioning of transformers of higher power but also very often the addition of a second transformer of at least equivalent power.

In addition, in some cases, the power transformers cannot exceed a certain size, it not being possible for transformers which are too large to be easily transported and installed.

There thus exists today a problem concerning the stock of existing transformers, which is already saturated or at the very least which is close to saturation. There at present remains a need to find a solution which makes it possible to increase the power of the present transformers, while maintaining a competitive manufacturing cost.

A third solution, which has already been proposed by vegetable oil manufacturers, is to use such vegetable oils known in particular for their high biodegradability. However, these oils often have viscosity problems, especially when cold, and dielectric characteristics which are inadequate and very often far inferior to those of mineral oils. In addition, the thermal properties and thus the heat exchanges are poorer than those of mineral oils. It is thus necessary to modify the internal structure of the transformers, in particular the widening of the oil circulation channels inside the windings. This change in design makes it necessary, for one and the same power, to increase the size of the transformer but also to use more materials and thus to increase the cost of manufacture of the transformers operating with these biodegradable oils.

The forecasts for the amount of electricity needed are constantly growing, so that it is essential to solve this problem today. The present invention makes it possible to solve, in whole or at the very least in part, the problems set out above.

This is because the inventors have now discovered that it is possible to use certain dielectric fluids in transformers in order to increase the power thereof, without it being necessary to have to modify their structure and/or their size.

Thus, and according to a first aspect, the present invention relates to the use, for increasing the power of a transformer, of at least one dielectric fluid of general formula (1):

(A-X)ₙ-B (1)

in which:
A and B, which are identical or different, represent, independently of each other, an aromatic ring optionally substituted by one or more saturated or partially or completely unsaturated hydrocarbon radicals comprising from 1 to 20 carbon atoms, preferably from 1 to 18 carbon atoms, more preferably from 1 to 12 carbon atoms, better still from 1 to 10 carbon atoms, even better still from 1 to 6 carbon atoms, typically from 1 to 3 carbon atoms,
X represents a spacer group chosen from a single bond, —O—, —S—, —(CRR′)ₘ—, >C═CRR′ and —NR″—,
R and R′, which are identical or different, are chosen, independently of each other, from hydrogen and a saturated or partially or completely unsaturated hydrocarbon radical comprising from 1 to 6 carbon atoms, preferably from 1 to 3 carbon atoms,
R″ represents a saturated or partially or completely unsaturated hydrocarbon radical comprising from 1 to 6 carbon atoms, preferably from 1 to 3 carbon atoms,
m represents an integer of between 1 and 4, limits included, and
n can be equal to 0 or represents an integer equal to 1, 2 or 3, preferably equal to 1 or 2, with the restriction that, when n is equal to 0, B is substituted by one or more hydrocarbon radicals, as defined above.

The term “aromatic ring” is understood to mean aromatic hydrocarbon monocycles and aromatic hydrocarbon polycycles, comprising from 6 to 20 carbon atoms. The term “polycycle” is understood to mean fused or condensed rings, at least one ring of which is aromatic, it being possible for the other ring(s) to be partially or completely unsaturated.

When n is equal to 0, the dielectric fluid of formula (1) defined above belongs to the family of the alkylbenzenes and preferably meets the specifications defined in the standard IEC 60867, edition 2 of 1993. When n is equal to 2 or 3, the (A-X) groups can be identical or different.

The dielectric fluids of formula (1) defined above are known and available or else can be easily prepared from procedures known in the patent literature, the scientific literature or on the Internet. Examples of dielectric fluids of formula (1) above are in particular described in the patents or patent applications EP 0 444 989, U.S. Pat. No. 5,017,733, EP 2 720 232, US2009103239 and U.S. Pat. No. 4,618,914, to mention only a few of them, by way of nonlimiting examples.

According to a preferred embodiment of the present invention, in the dielectric fluid of general formula (1), n is different from 0 and B is an aromatic ring substituted by a hydrocarbon radical. Preferably again, said hydrocarbon radical is an alkyl radical comprising from 1 to 6 carbon atoms, preferably from 1 to 4 carbon atoms, and preferably the alkyl radical is the methyl radical.

According to another preferred embodiment of the present invention, in the dielectric fluid of general formula (1), n is equal to 0 and the dielectric fluid of formula (1) is generally chosen from linear alkylbenzenes and branched alkylbenzenes, such as, for example and in a nonlimiting way, alkylbenzenes in which the alkyl part comprises from 10 to 20 carbon atoms. Such alkylbenzenes comprise, still in a nonlimiting way, decylbenzene, dodecylbenzene and octadecylbenzene, to mention only a few of them.

All the dielectric fluids corresponding to the general formula (1) above can be used, alone or as mixtures of two or more of them in all proportions. In one embodiment, the use according to the present invention employs at least one dielectric fluid of formula (1) defined above, alone or as a mixture with one or more other dielectric fluids known to a person skilled in the art, such as, for example and without limitation, dielectric fluids chosen from mineral oils, vegetable oils and natural or synthetic esters.

The amount of dielectric fluid(s) according to the general formula (1) with respect to the totality of all of the dielectric fluids which can be used for the requirements of the present invention can vary within large proportions. It is, however, preferred to use the dielectric fluids according to the general formula (1) defined above in proportions of between 50% and 100% by weight, limits included, preferably between 70% and 100% by weight, limits included, with respect to the totality of all of the dielectric fluids which can be used for the requirements of the present invention.

According to yet another preferred embodiment of the present invention, the dielectric fluid is chosen from benzyltoluene (BT), dibenzyltoluene (DBT) and their mixtures in all proportions. The preferred BT/DBT mixtures are those comprising between 1% and 50%, limits included, by weight of benzyltoluene and more preferably between 15% and 30%, limits included, by weight of dibenzyltoluene, with respect to the total amount of benzyltoluene/dibenzyltoluene.

In a very particularly preferred embodiment, the dielectric fluid is chosen from the dielectric fluids sold by Arkema under the brand names of the Jarylec® range.

Other dielectric fluids suitable for the requirements of the present invention are, for example, those sold by Yantai Jinzheng, in particular under the brand name SRS-401T, those sold by Jinzhou Yongia, in particular M/DBT, and those sold by JX Nippon, in particular under the brand name SAS-60E.

Mention may be made, as yet other examples of dielectric fluids suitable for the requirements of the present invention, of:
diphenylethane (DPE) and its isomers, especially 1,1-DPE (CAS 612-00-0), 1,2-DPE (CAS 103-29-7) and their mixtures (in particular CAS 38888-98-1); such fluids are available commercially or described in the literature, for example in the document EP 0 098 677,
ditolyl ether (DT) and its isomers, especially those corresponding to the numbers CAS 4731-34-4 and CAS 28299-41-4 and their mixtures, these being in particular commercially available from Lanxess, under the brand name DiphylDT,
phenylxylylethane (PXE) and its isomers, especially those corresponding to the numbers CAS 6196-95-8 and CAS 76090-67-0 and their mixtures, in particular commercially available from Changzhou Winschem, under the brand name PXE Oil,
1,2,3,4-tetrahydro-(1-phenylethyl)naphthalene (CAS 63674-30-6), this product being commercially available in particular from Dow under the reference Dowtherm™ RP,
diisopropylnaphthalene (CAS 38640-62-9), available in particular from Indus Chemie Ltd under the brand name KMC 113,
monoisopropylbiphenyl and its isomers (CAS 25640-78-2), in particular available under the brand name Wemcol, and
phenylethylphenylethane (PEPE) and its isomers (CAS 6196-94-7), in particular available from Changzhou Winschem or Yantai Jinzheng, to mention only the main dielectric fluids known and usable in the context of the present invention.

The dielectric fluid which can be used in the context of the present invention can in addition contain one or more additives well known to a person skilled in the art specializing in transformers and for example chosen from antioxidants, passivators, pour point depressants, decomposition inhibitors and their mixtures. A dielectric fluid which is very particularly preferred comprises a decomposition inhibitor.

Mention may be made, among the antioxidants which can be advantageously used in the dielectric fluid, as nonlimiting examples, of phenolic antioxidants, such as, for example, butylated hydroxytoluene, butylated hydroxyanisole, tocopherols, as well as the acetates of these phenolic antioxidants; but also antioxidants of amine type, such as, for example, phenyl-α-naphthylamine, of diamine type, for example N,N′-di(2-naphthyl)-para-phenylenediamine, but also ascorbic acid and its salts, esters of ascorbic acid, alone or as mixtures of two or more of them or with other components, such as, for example, green tea extracts or coffee extracts.

A very particularly suitable antioxidant is that commercially available from Brenntag under the trade name Ionol®.

The passivators which can be used as additives in the dielectric fluid which can be used in the context of the present invention are of any type known to a person skilled in the art and are advantageously chosen from triazole derivatives, benzimidazoles, imidazoles, thiazole or benzothiazole. Mention may be made, by way of example and in a nonlimiting way, of dioctylaminomethyl-2,3-benzotriazole and 2-dodecyldithio-imidazole.

Mention may be made, among the pour point depressants which can be present in the dielectric fluid which can be used in the context of the present invention, as nonlimiting examples, of sucrose fatty acid esters or acrylic polymers, such as poly(alkyl methacrylate) or poly(alkyl acrylate).

The preferred acrylic polymers are those, the molecular weight of which is between 50 000 g·mol⁻¹ and 500 000 g·mol⁻¹. Examples of these acrylic polymers include polymers which can contain linear alkyl groups comprising from 1 to 20 carbon atoms.

Mention may be made, among these and still as nonlimiting examples, of poly(methyl acrylate), poly(methyl methacrylate), poly(heptyl acrylate), poly(heptyl methacrylate), poly(nonyl acrylate), poly(nonyl methacrylate), poly(undecyl acrylate), poly(undecyl methacrylate), poly(tridecyl acrylate), poly(tridecyl methacrylate), poly(pentadecyl acrylate), poly(pentadecyl methacrylate), poly(heptadecyl acrylate) and poly(heptadecyl methacrylate).

An example of such a pour point depressant is commercially available from Sanyo Chemical Industries Ltd under the brand name Aclube.

According to a very particularly preferred aspect, the dielectric fluid which can be used in the context of the present invention comprises at least one decomposition inhibitor as additive. The decomposition inhibitor can be of any type well known to a person skilled in the art and in particular can be chosen from carbodiimide derivatives, such as diphenylcarbodiimide, ditolylcarbodiimide, bis(isopropylphenyl)carbodiimide or bis(butylphenyl)carbodiimide, but also from phenyl glycidyl ethers, or esters, alkyl glycidyl ethers, or esters, 3,4-epoxycyclohexylmethyl 3,4-epoxycyclohexanecarboxylate, compounds of the anthraquinone family, such as, for example, β-methylanthraquinone sold under the name “BMAQ”, epoxy derivatives, such as vinylcyclohexene diepoxides, 3,4-epoxy-6-methylcyclohexylmethyl 3,4-epoxy-6-methylhexanecarboxylate, epoxy resins of phenol novolak type, bisphenol A diglycidyl ether epoxys, such as BADGE, or CEL 2021P, available in particular from Whyte Chemical.

According to a specific embodiment of the invention, the dielectric fluid which can be used in the context of the present invention comprises at least one decomposition inhibitor.

The content by weight of the additive or additives optionally present in the dielectric fluid which can be used in the context of the present invention can range from 0.0001% to 2% by weight, preferably from 0.001% to 1% by weight and more preferably from 0.01% to 0.5% by weight, limits included, with respect to the total weight of the mixture.

The inventors have now discovered that the use of at least one dielectric fluid of formula (1) as defined above in a transformer makes it possible to be able to increase the power of said transformer. The power gain can vary and is generally of the order of 2% to 15%. This power gain depends on the amount and nature of the fluid(s) of formula (1) which is (are) used in said transformer.

Within the meaning of the present invention, a “transformer” can be any type of electrical transformer known to a person skilled in the art, and in particular any type of transformer referred to as distribution or power or traction transformer.

The present invention thus makes it possible, for a given transformer, to be able to increase its power by a factor generally of between 2% and 15%, without modifying either its technology or its size, this increase being obtained by the use of at least one dielectric fluid according to the general formula (1) defined above, or else by replacing all or part of the dielectric fluid contained in a transformer by at least one dielectric fluid according to the general formula (1) defined above.

The increase in power, or power gain, indicated above can be estimated on the basis of the heat transfer parameters. Without wishing to be committed to the theory, a greater prompting for power from a transformer is reflected by an increase in the temperature of said transformer and of the dielectric fluid which it contains. In point of fact, some dielectric fluids only moderately withstand temperature variations or again are poor heat-exchange fluids, so that it is not desirable to increase their power, without the risk of significantly reducing the lifetime of the transformer.

The present invention also relates to a transformer, preferably a distribution or power transformer, containing at least one dielectric fluid of formula (1) as defined above.

More specifically, the present invention relates to a transformer containing at least one dielectric fluid of formula (1) as defined above, alone or as a mixture with one or more other dielectric fluids known to a person skilled in the art, such as, for example and without limitation, dielectric fluids chosen from mineral oils, vegetable oils and natural or synthetic esters.

According to a preferred embodiment, the present invention relates to a transformer in which the dielectric fluid comprises at least one dielectric fluid of general formula (1) defined above, optionally with another dielectric fluid chosen from mineral oils, vegetable oils and natural or synthetic esters.

According to another preferred embodiment, said transformer comprises between 50% and 100% by weight, limits included, preferably between 70% and 100% by weight, limits included, with respect to the totality of all of the dielectric fluids, of at least one dielectric fluid corresponding to the general formula (1) as defined above.

According to a very particularly preferred aspect, the present invention relates to a transformer comprising a dielectric fluid chosen from benzyltoluene (BT), dibenzyltoluene (DBT) and their mixtures in all proportions.

According to a preferred embodiment, the transformer according to the invention contains an amount of chlorinated compound(s) of less than 100 ppm by weight, preferably of less than 50 ppm by weight, with respect to the total weight of the composition. Preferably again, the transformer according to the invention does not contain chlorinated compound(s).

The following examples make it possible to obtain a better understanding of the invention and are presented by way of illustration, without however limiting in any way whatsoever the scope of protection requested and defined by the claims appended to the present description.

### EXAMPLE

### Comparison of Available Power Between a Mineral Oil and a Dielectric Fluid of Formula (1)

For the requirements of the example, use is made of two identical three-phase 160 kVA transformers, with a transformation factor of 15 kV to 0.4 kV. The comparative study is carried out with a transformer containing the mineral oil NYTRO Libra sold by Nynas, on the one hand, and with a transformer containing a Jarylec® sold by Arkema, on the other hand. The Jarylec® is a BT/DBT mixture.

A measurement of the temperature of the dielectric fluid contained in the transformer is carried out at the top of the phases, with respect to the charge of the transformer. The charging time to reach the temperature is 5 hours. All the conditions are the same over the 2 tests with the mineral oil and the Jarylec® sold by Arkema and in particular the condition with regard to the outside temperature, which is ambient temperature.

The voltage applied corresponds to the percentage of the nominal impedance of the short-circuit given by the manufacturer of the transformer. This impedance corresponds to 3.63% of the nominal voltage of 15 kV. Thus, at 100% charge, the voltage applied is approximately (15 000×0.0363) V.

The results of the tests are presented in tables 1 and 1a below:

TABLE 1

| Charge | Ambient | Temperature | Temper- | Applied |
|---|---|---|---|---|
| of the | temperature | (° C.) | ature | voltage |
| transformer | (° C.) | NYTRO Libra | difference | (V) |
| 70% | 28.5 | 55.2 | 26.7 | 389 |
| 100% | 28.8 | 76.3 | 47.5 | 557 |
| 115% | — | — | — | 640 |

TABLE 1a

| Charge | Ambient | Temperature | Temper- | Applied |
|---|---|---|---|---|
| of the | temperature | (° C.) | ature | voltage |
| transformer | (° C.) | Jarylec ® | difference | (V) |
| 70% | 28.4 | 52.3 | 23.9 | 389 |
| 100% | 28.7 | 72.1 | 43.4 | 557 |
| 115% | 28.7 | 76.5 | 47.8 | 640 |

A temperature difference of the same order of magnitude is obtained for a charge of 100% with the mineral oil and for a charge greater by 15% (i.e. 115%) with the Jarylec®. This shows that it is possible, with a dielectric fluid of general formula (1), to increase the power of a transformer, without causing overheating, in comparison with one and the same transformer not comprising dielectric fluid according to the general formula (1).

1-10. (canceled)

11. A method of increasing the power of a transformer comprising using at least one dielectric fluid having a general formula (1):
(A-X)ₙ-B (1)
wherein:
A and B, which are identical or different, represent, independently of each other, an aromatic ring optionally substituted by one or more saturated or partially or completely unsaturated hydrocarbon radicals comprising from 1 to 20 carbon atoms,
X represents a spacer group selected from the group consisting of a single bond, —O—, —S—, —(CRR′)ₘ—, >C═CRR′ and —NR″—,
R and R′, which are identical or different, are chosen, independently of each other, from hydrogen and a saturated or partially or completely unsaturated hydrocarbon radical comprising from 1 to 6 carbon atoms,
R″ represents a saturated or partially or completely unsaturated hydrocarbon radical comprising from 1 to 6 carbon atoms,
m represents an integer of between 1 and 4, limits included, and
n can be equal to 0 or represents an integer equal to 1, 2 or 3, with the restriction that, when n is equal to 0, B is substituted by one or more hydrocarbon radicals, as defined above.

12. The method of claim 11, wherein, in the dielectric fluid of general formula (1), n is different from 0 and B is an aromatic ring substituted by a hydrocarbon radical.

13. The method of claim 11, wherein, in the dielectric fluid of general formula (1), n is different from 0 and B is an aromatic ring substituted by an alkyl radical comprising from 1 to 6 carbon atoms.

14. The method of claim 11, wherein the at least one dielectric fluid of formula (1) is used in a mixture with one or more other dielectric fluids chosen from mineral oils, vegetable oils and natural or synthetic esters.

15. The method of claim 11, wherein the at least one dielectric fluid is chosen from benzyltoluene, dibenzyltoluene and their mixtures in all proportions.

16. The method of claim 11, wherein the at least one dielectric fluid is a benzyltoluene/dibenzyltoluene mixture comprising between 1% and 50%, limits included, with respect to the total amount of benzyltoluene/dibenzyltoluene.

17. The method of claim 11, wherein the at least one dielectric fluid further comprises one or more additives chosen from antioxidants, passivators, pour point depressants, decomposition inhibitors and their mixtures.

18. The method of claim 11, wherein the dielectric fluid comprises at least one decomposition inhibitor selected from the group consisting of carbodiimide derivatives, phenyl glycidyl ethers, or esters, alkyl glycidyl ethers, or esters, 3,4-epoxycyclohexylmethyl 3,4-epoxycyclohexanecarboxylate, compounds of the anthraquinone family, epoxy derivatives, 3,4-epoxy-6-methylcyclohexylmethyl 3,4-epoxy-6-methylhexanecarboxylate, and epoxy resins of phenol novolak type or bisphenol A diglycidyl ether epoxys.

19. A transformer containing at least one dielectric fluid of formula (1) as defined in claim 11.

20. The transformer as claimed in claim 19, which is a distribution transformer or a power transformer.
